(19) United States
(12) Patent Application Publication
(10) Pub. No.: US 2026/0323300 A1
(43) Pub. Date: Oct. 15, 2026

(54) SYSTEMS AND METHODS FOR UTILIZING MACHINE LEARNING TO CREATE A POLICY FOR DEVICE MANAGEMENT

(71) Applicant: Verizon Patent and Licensing Inc., Basking Ridge, NJ (US)

(72) Inventors: Jyotsna KACHROO, Millburn, NJ (US); Christopher Lee RUTLEDGE, Somerset, NJ (US); Umesh Kumar GUPTA, Morris Plains, NJ (US)

(73) Assignee: Verizon Patent and Licensing Inc., Basking Ridge, NJ (US)

(21) Appl. No.: 19/179,314

(22) Filed: Apr. 15, 2025

(51) Int. Cl. H04W 12/37

(52) U.S. Cl. CPC H04W 12/37

(57) ABSTRACT

A device may receive real-time data associated with a user device connected to a network, and may analyze the real-time data. The device may identify an event affecting the user device based on analyzing the real-time data, and may utilize a machine learning model to generate a policy for the user device based on the event. The device may implement the policy for the user device, and may monitor implementation of the policy for the user device. The device may receive performance data based on monitoring the implementation of the policy for the user device, and may update the machine learning model based on the performance data to generate an updated machine learning model.

### BACKGROUND

Management of mobile user devices within enterprise environments may be a critical component of information technology (IT) operations, and ensures that the mobile devices adhere to security policies and effectively support needs of users of the mobile devices.

### BRIEF DESCRIPTION OF THE DRAWINGS

FIGS. 1A-1D are diagrams of an example associated with utilizing machine learning to create a policy for device management.

FIG. 2 is a diagram illustrating an example of training and using a machine learning model.

FIG. 3 is a diagram of an example environment in which systems and/or methods described herein may be implemented.

FIG. 4 is a diagram of example components of one or more devices of FIG. 3.

FIG. 5 is a flowchart of an example process for utilizing machine learning to create a policy for device management.

### DETAILED DESCRIPTION OF EXAMPLE EMBODIMENTS

The following detailed description of example implementations refers to the accompanying drawings. The same reference numbers in different drawings may identify the same or similar elements.

A mobile device management (MDM) system or a unified endpoint management (UEM) system may control and secure mobile devices across a network that includes various platforms and carriers. However, current MDM/UEM systems often rely on static configurations and pre-defined policies that may not adapt swiftly to dynamic events or contextual changes occurring in a network. Static MDM/UEM systems may be required to respond to a variety of data points and triggers, such as network connectivity, device location, battery level, and natural disasters (e.g., earthquakes, floods, forest files, and/or the like). However, managing such a wide array of triggers effectively is challenging for static MDM/UEM systems, especially when relying on simple Boolean logic without a capacity for learning or adaptation. This may lead to suboptimal policy enforcement, delayed responses to critical events, and an overall lack of tailored user experiences for specific situations, such as providing first responders with the necessary tools during an emergency. Moreover, administration of MDM/UEM systems may be complex and labor-intensive, often requiring IT personnel to manually create and update policies. This can be a significant burden, particularly in larger organizations with diverse device ecosystems and rapidly changing conditions.

Thus, current techniques for managing mobile devices consume computing resources (e.g., processing resources, memory resources, communication resources, and/or the like), networking resources, and/or other resources associated with failing to properly adapt to dynamic events or contextual changes occurring in a network, failing to generate policies that adapt to the dynamic events or contextual changes occurring in a network, generating erroneous policies in response to the dynamic events or contextual changes occurring in a network, handling poor mobile device experiences caused by the erroneous policies, and/or the like.

Some implementations described herein provide a management system that utilizes machine learning to create policies for device management. For example, a management system may receive real-time data associated with a user device connected to a network, and may analyze the real-time data. The management system may identify an event affecting the user device based on analyzing the real-time data, and may utilize a machine learning model to generate a new or revised policy for the user device based on the event. The management system may implement the policy for the user device, and may then monitor implementation of the policy for the user device. The management system may receive performance data based on monitoring the implementation of the policy for the user device, and may update the machine learning model based on the performance data to generate an updated machine learning model. In some implementations, the management system may also update the newly implemented policy based on the performance data.

In this way, the management system utilizes machine learning to create policies for device management. For example, the management system may improve dynamic and adaptive mobile device management by using real-time data and machine learning, which may enable the management system to respond effectively to a wide array of network conditions and events. The management system facilitates optimal policy enforcement and swift adaptation to critical events, ensuring that mobile devices operate within predefined parameters, e.g., security and operational parameters. By automating policy creation and adaptation, the management system may reduce the workload on IT personnel and may minimize the potential for errors associated with manual policy management. The generated policies may include rules for managing various functionalities of the mobile devices. The management system may monitor feedback from implementation of the policies, and may update machine learning models based on the feedback to create improved policies. Additionally, the management system may utilize inputs from network administrators, such as natural language inputs, to further refine policy generation. Thus, the management system may conserve computing resources, networking resources, and/or other resources that would have otherwise been consumed by failing to properly adapt to dynamic events or contextual changes occurring in a network, failing to generate policies that adapt to the dynamic events or contextual changes occurring in a network, generating erroneous policies in response to the dynamic events or contextual changes occurring in a network, handling poor mobile device experiences caused by the erroneous policies, and/or the like.

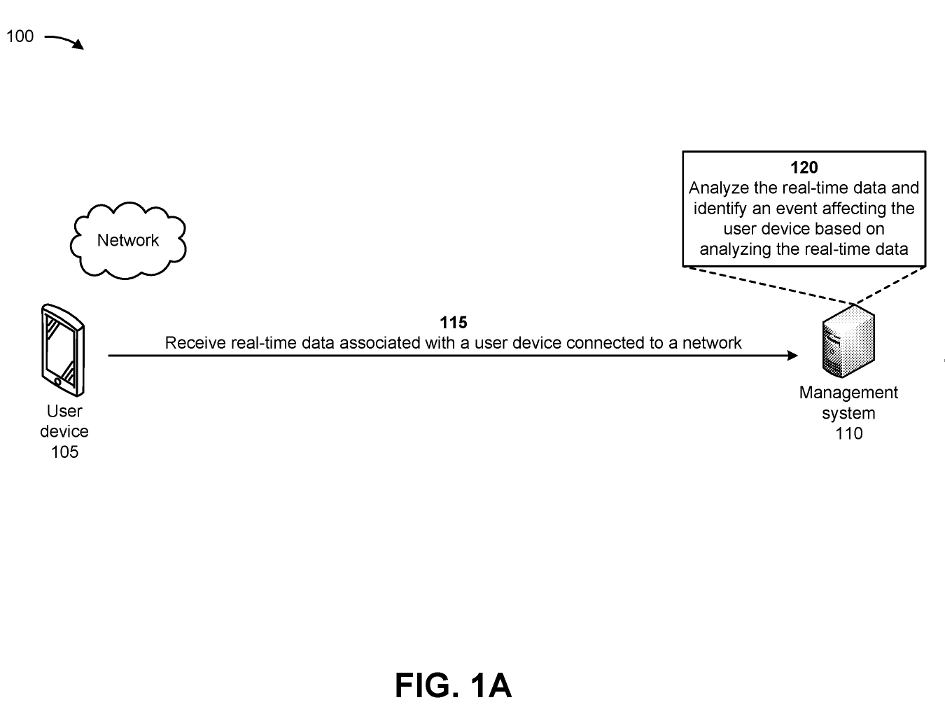

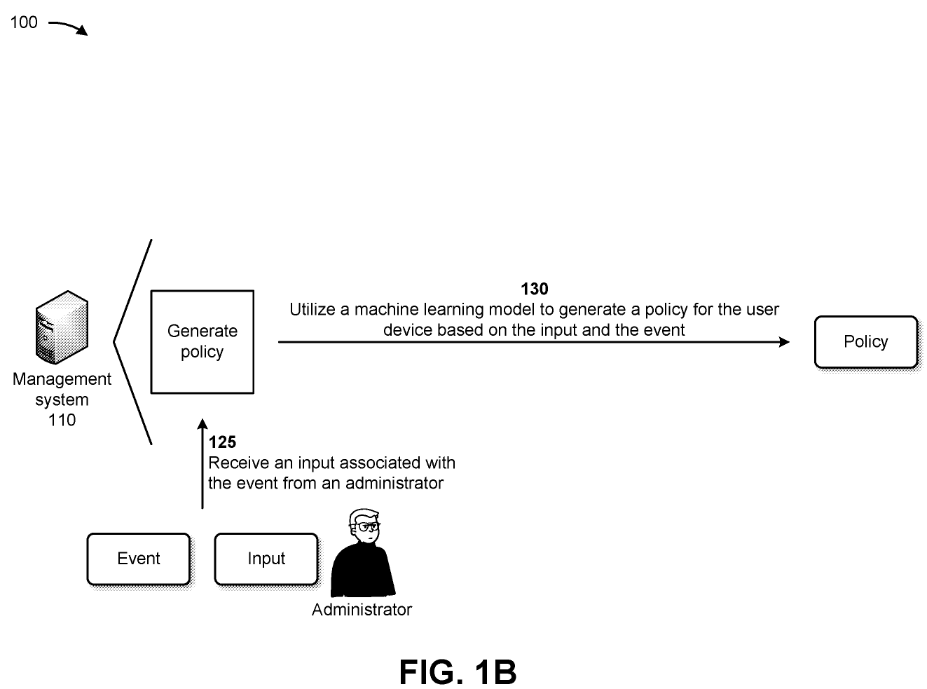

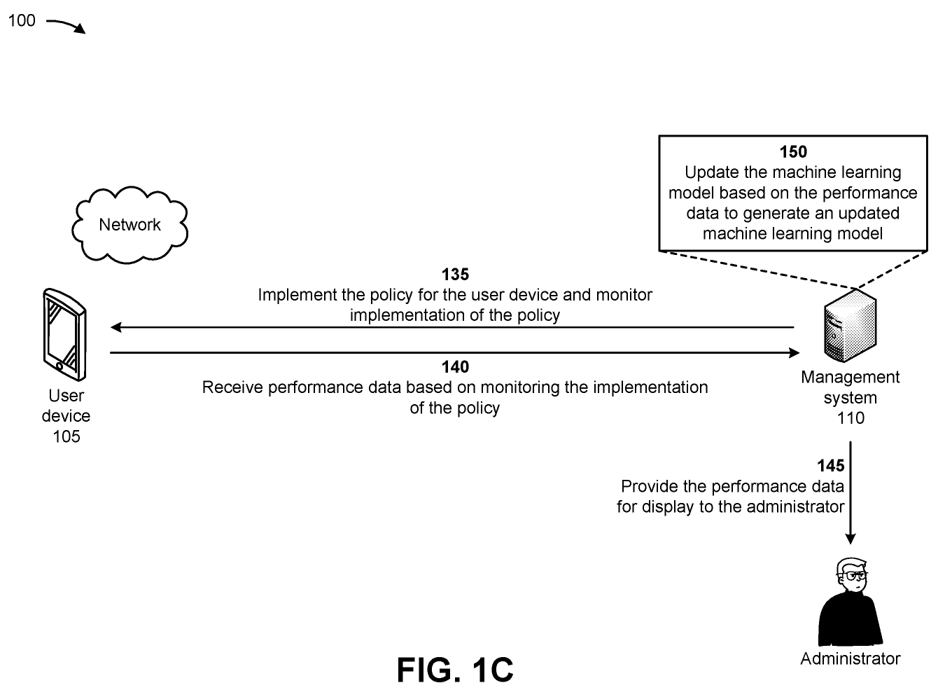

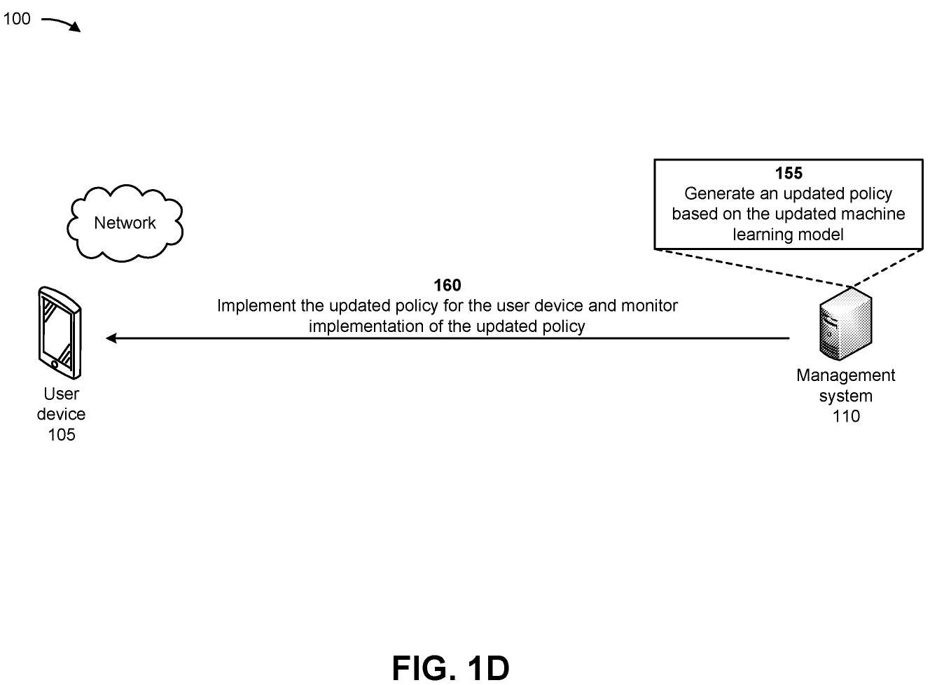

FIGS. 1A-1D are diagrams of an example 100 associated with utilizing machine learning to create a policy for device management. As shown in FIGS. 1A-1D, the example 100 includes a user device 105 associated with a network and a management system 110. The user device 105 may be a mobile device that utilizes the network for telecommunications. The management system 110 may include a system that utilizes machine learning to create a policy for device management. Further details of the user device 105 and the management system 110 are provided elsewhere herein. Although implementations described herein depict a single user device 105, in some implementations, the management system 110 may be associated with multiple user devices 105.

As shown in FIG. 1A, and by reference number 115, the management system 110 may receive real-time data associated with a user device 105 connected to a network. For example, the user device 105 may perform several functions when connected to the network, and may generate the real-time data based on performing the functions. In some implementations, the user device 105 may monitor data usage (e.g., a quantity of data being used for various activities such as browsing the Internet, streaming videos, downloading files, and using applications). The user device 105 may perform location tracking by continuously or periodically updating a geographical location of the user device 105 using global positioning system (GPS) or network-based location services. The user device 105 may utilize the geographical location for navigation, location-based services, and tracking. The user device 105 may perform memory management by monitoring available memory to ensure efficient storage and retrieval of data, applications, and other digital content. The user device may perform environmental condition monitoring by collecting data related to environmental conditions, such as temperature, humidity, and air quality, using built-in sensors.

The user device 105 may keep track of a roaming status of the user device 105. The roaming status may indicate whether the user device 105 is connected to a home network or a foreign network, which may affect data usage and connectivity. The user device 105 may manage encrypted storage to secure sensitive data and ensure that the data is protected from unauthorized access. The user device 105 may monitor a battery level of the user device 105 to manage power consumption and optimize performance. The user device 105 may periodically check for updates to an operating system and installed applications to ensure that they are up-to-date with the latest features and security patches. The user device 105 may collect and manage user identification information to personalize a user experience, secure access, and provide tailored services.

The user device 105 may generate the real-time data while performing the functions associated with the network, and may provide the real-time data to the management system 110. The management system 110 may continuously receive the real-time data from the user device 105, may periodically receive the real-time data from the user device 105, may receive the real-time data from the user device 105 based on a request, and/or the like. In some implementations, the real-time data may include data usage data associated with the user device 105, location data associated with the user device 105, available memory data associated with the user device 105, environmental condition data associated with the user device 105, roaming status associated with the user device 105, encrypted storage data associated with the user device 105, battery level associated with the user device 105, operating system version associated with the user device 105, identification of a user of the user device 105, and/or the like. In some implementations, the management system 110 may receive the real-time data associated with the event from various data sources. For example, the data sources may include network sensors, user device logs, or external databases that provide relevant information about the event. The real-time data may ensure that the management system 110 has sufficient information to accurately assess the state and needs of the user device 105, and to effectively monitor and manage the user device 105.

As further shown by FIG. 1A, and by reference number 120, the management system 110 may analyze the real-time data and may identify an event affecting the user device 105 based on analyzing the real-time data. For example, the management system 110 may use various analytical techniques, including machine learning models, to process the real-time data and detect numerous events, such as changes in network connectivity, battery depletion, or movement into a specific geographical area. These analytical techniques may include pattern recognition and predictive analysis to determine significant events affecting the user device 105. The machine learning models may enhance the accuracy and efficiency of event detection by the management system 110. The identification of such events may trigger subsequent actions, such as generation of a new or revised policy for managing the user device 105, as described below.

As shown in FIG. 1B, and by reference number 125, the management system 110 may receive an input associated with the event from an administrator. For example, an administrator (e.g., a network administrator) may communicate with the management system 110 (e.g., via a computing device). The management system 110 may provide a user interface for display to the administrator. The user interface may display the event and may enable the administrator to provide an input (e.g., a natural language input) or other data related to the event, such as a specific requirement or condition to be addressed by a policy to address the event. The input may include data identifying a priority level for a policy, specific actions to be taken by the policy, any constraints to be considered by the policy, and/or the like. The administrator may utilize the user interface to provide the input associated with the event, and the management system 110 may receive the input via the user interface. In some implementations, the user interface may include a chatbot assistance tool for assisting the administrator to generate policies, create configurations, and/or the like. The chatbot assistance tool may guide the administrator with respect to policy generation, may enhance an overall user experience for the administrator, may enable the administrator to verify a policy, may alert the administrator about policy errors, and/or the like.

Additionally, or alternatively, the management system 110 may receive the input associated with the event from an automated system. For example, the automated system may detect anomalies or specific conditions that trigger a need for a policy update, without requiring manual input from the administrator. Additionally, or alternatively, the management system 110 may receive the input associated with the event from a collaborative interface. For example, multiple administrators may provide input through a collaborative platform, ensuring that diverse perspectives and requirements are considered in the policy creation. Additionally, or alternatively, the management system 110 may receive the input associated with the event from user feedback. For example, a user of the user device 105 may experience issues or specific needs, and may provide feedback that influences policy adjustments made by the management system 110. Additionally, or alternatively, the management system 110 may receive the input associated with the event from a network sensor. For example, a network sensor detecting physical or network conditions may provide the input to the management system 110, prompting the generation of a responsive policy.

As further shown in FIG. 1B, and by reference number 130, the management system 110 may utilize a machine learning model to generate a policy for the user device 105 based on the input and the event. For example, the management system 110 may be associated with a machine learning model, such as a neural network model. The neural network model may include layers of interconnected nodes (e.g., or neurons), where each connection has an associated weight. The neural network model may process input data through these layers, with each node applying a transformation to an input received by the node, often using an activation function.

The neural network model may be constructed using a combination of supervised and unsupervised learning techniques. The training process for the neural network model begins with the collection of historical data from various user devices 105 within the network. This data includes logs of device usage, network conditions, user interactions, environmental factors, and/or the like. The historical data may be collected from multiple sources (e.g., device logs, network sensors, and environmental databases), and may be aggregated into a centralized data repository. The data may then be pre-processed to remove any inconsistencies or errors. This may include normalizing numerical values, encoding categorical variables, and handling missing data through imputation techniques. The pre-processed data may be split into training, validation, and test datasets to ensure robustness of the neural network model.

Feature engineering may be performed by selecting and creating relevant features that will be used as inputs to the neural network model. The features may include device battery level, network signal strength, application usage patterns, and real-time location data. Additional features may be derived by combining existing ones, such as calculating the rate of battery depletion over time or the frequency of connectivity drops.

The neural network model may include multiple layers, including input, hidden, and output layers. Each layer may include several nodes or neurons that apply activation functions to the input data. The hidden layers may utilize rectified linear unit (ReLU) activation functions, which help in handling non-linear relationships within the data. The output layer may utilize a softmax activation function for classification tasks or a linear function for regression tasks, depending on the target variable.

The neural network model may be trained using a backpropagation algorithm, which adjusts the weights of the neurons to minimize the error between predicted and actual outcomes. An optimization may be performed using an Adam optimizer. During training, the neural network model may undergo several epochs, where it iterates over the entire training dataset multiple times. Early stopping may be implemented to prevent overfitting, where the training is halted if the validation error does not improve after a certain number of epochs.

The management system 110 may process the input and the event, with the machine learning model, to generate the policy for the user device 105 that addresses identified needs or conditions. The generated or revised policy may include specific rules and actions for managing the functionalities of the user device 105, ensuring that the user device 105 operates optimally in response to the event. In some implementations, the management system 110 may utilize the machine learning model to generate a policy for the user device 105 based on historical event data. For example, the machine learning model may analyze past events and corresponding responses to predict and formulate an optimal policy for the current event. Additionally, or alternatively, the management system 110 may utilize the machine learning model to generate a policy for the user device 105 based on predefined templates. For example, the machine learning model may select and customize a policy template that best matches characteristics and requirements of the event.

Additionally, or alternatively, the management system 110 may utilize a machine learning model to generate a policy for the user device 105 based on real-time environmental data. For example, the machine learning model may factor in current environmental conditions, such as weather or network congestion, to tailor the policy accordingly. Additionally, or alternatively, the management system 110 may utilize a machine learning model to generate a policy for the user device 105 based on dynamic prioritization. For example, the machine learning model may prioritize certain actions or functionalities of the user device 105 based on the criticality and urgency of the event. Additionally, or alternatively, the management system 110 may utilize a machine learning model to generate a policy for the user device 105 based on user profiles. For example, the machine learning model may take into account the specific preferences and usage patterns of a user of the user device 105 to create a personalized policy in response to the event.

As shown in FIG. 1C, and by reference number 135, the management system 110 may implement the policy for the user device 105 and may monitor implementation of the policy. For example, the management system 110 may deploy the policy to adjust one or more functionalities of the user device 105 and/or resources of the network in response to the event occurring in the network. In some implementations, the management system 110 may provide the policy to the user device 105 and/or the network resources, and may instruct the user device 105 and/or the network resources to implement the revised, updated or new policy by adjusting the one or more functionalities of the user device 105 and/or the network resources. In some implementations, the management system 110 may dynamically deploy the policy to adjust one or more functionalities of the user device 105 in response to detected environmental conditions. For example, the management system 110 may alter device settings of the user device 105 based on temperature, humidity, or other environmental factors to maintain optimal performance.

Additionally, or alternatively, implementing the policy may include the management system 110 modifying network resource allocation for the user device 105 based on the policy and network conditions to optimize performance. For example, the management system 110 may adjust bandwidth allocation to the user device 105 during peak usage periods to ensure smooth operation. Additionally, or alternatively, implementing the new or revised policy may include the management system 110 prioritizing certain functionalities of the user device 105, such as security settings or critical application updates, based on the policy and current network status. This may ensure that essential functions of the user device 105 are maintained even during periods of high network load.

The management system 110 may monitor the implementation of the policy to ensure that the user device 105 and/or the network resources are properly implementing the policy. By monitoring the policy implementation, the management system 110 may ensure that the user device 105 operates optimally under the new policy settings. In some implementations, the management system 110 may receive new real-time data after implementation of the policy, and may monitor the implementation of the policy based on the real-time data.

As further shown in FIG. 1C, and by reference number 140, the management system 110 may receive performance data based on monitoring the implementation of the policy. For example, the user device 105 and/or the network resources may generate the performance data based on implementing the policy. The management system 110 may receive the performance data from user device 105 and/or the network resources based on monitoring the implementation of the policy. The performance data may include metrics and indicators that show how well the user device 105 is functioning under the new policy, providing insights into the effectiveness of the policy. In some implementations, the management system 110 may analyze the performance data to determine if the implemented policy needs adjustments to better suit changing behavior or usage patterns of the user device 105. For example, the management system 110 may track user interaction with the user device 105 and may adjust the policy to enhance a user experience. Additionally, or alternatively, the management system 110 may integrate inputs from external data sources (e.g., weather predictions or network congestion alerts) with the performance data, to refine the policy for the user device 105. This may ensure that the policy remains relevant and effective under varying conditions.

As further shown in FIG. 1C, and by reference number 145, the management system 110 may provide the performance data for display to the administrator. For example, the management system 110 may include the performance data in a user interface, and may provide the user interface for display to the administrator. This may enable the administrator to review the performance data and assess the performance of the user device 105 under the implemented policy. In some implementations, the management system 110 may enable real-time visualization of the performance data for the administrator to facilitate proactive management of the user device 105. This may enable the administrator to make timely adjustments to the policy as needed. Additionally, or alternatively, the management system 110 may provide, for display to the administrator, a user interface that enables the administrator to modify policy parameters and visualize the anticipated effects of the modified policy parameters on the user device 105. Additionally, or alternatively, the management system 110 may provide recommendations to the administrator for policy adjustments based on trends identified in the performance data.

As further shown in FIG. 1C, and by reference number 150, the management system 110 may update the machine learning model based on the performance data to generate an updated machine learning model. For example, the management system 110 may retrain the machine learning model based on the performance data and to generate the updated machine learning model. This update may ensure that the machine learning model evolves and improves over time, incorporating new data and adapting to changes in the network and in conditions of the user device 105. In some implementations, retraining the machine learning model may include the management system 110 adjusting the machine learning model based on the performance data collected during the enforcement of the policy.

In some implementations, updating the machine learning model may include the management system 110 employing a neural network model to continuously learn from the performance data and improve the accuracy of policy adjustments for the user device 105. This continuous learning process can lead to more precise and effective policy implementations. In some implementations, this may guarantee that the machine learning model remains responsive and adjusts to fluctuating network dynamics and device activities, leading to more accurate and efficient policy executions. Additionally, or alternatively, updating the machine learning model may enable the machine learning model to continuously evolve and adapt to varying network environments and user device interactions. Continuous adaptation ensures that the model remains relevant and effective.

As shown by FIG. 1D, and reference number 155, the management system 110 may generate an updated policy based on the updated machine learning model. For example, the management system 110 may process the input and the event, with the updated machine learning model, to generate the updated policy. The updated policy may include specific rules and actions for managing the functionalities of the user device 105, ensuring that the user device 105 operates optimally in response to the event. Additionally, or alternatively, the management system 110 may generate the updated policy after analyzing the performance data to fine-tune recommendations of the machine learning model. By analyzing the performance data, the management system 110 may make precise adjustments to the generated policy. In some implementations, the policy may include an enhanced policy with insights gained from ongoing policy performance monitoring. The insights may include observed trends and user behavior data that can significantly improve policy effectiveness.

As further shown in FIG. 1D, and by reference number 160, the management system 110 may implement the updated policy for the user device 105 and may monitor implementation of the updated policy. For example, the management system 110 may deploy the updated policy to adjust one or more functionalities of the user device 105 and/or network resources in response to the event occurring in the network. In some implementations, the management system 110 may provide the updated policy to the user device 105 and/or the network resources, and may instruct the user device 105 and/or the network resources to implement the updated policy by adjusting the one or more functionalities of the user device 105 and/or the network resources. In some implementations, the management system 110 may dynamically deploy the updated policy to adjust one or more functionalities of the user device 105 in response to detected environmental conditions. For example, the management system 110 may alter device settings of the user device 105 based on temperature, humidity, or other environmental factors to maintain optimal performance.

Additionally, or alternatively, the management system 110 may modify network resource allocation for the user device 105 based on the updated policy and network conditions to optimize performance. For example, the management system 110 may adjust bandwidth allocation to the user device 105 during peak usage periods to ensure smooth operation. Additionally, or alternatively, implementing the updated policy may include the management system 110 prioritizing certain functionalities of the user device 105, such as security settings or critical application updates, based on the updated policy and current network status. This may ensure that essential functions of the user device 105 are maintained even during periods of high network load.

The management system 110 may monitor the implementation of the updated policy to ensure that the user device 105 and/or the network resources are properly implementing the updated policy. By monitoring the updated policy implementation, the management system 110 may ensure that the user device 105 operates optimally under the updated policy settings. In some implementations, the management system 110 may receive new real-time data after implementation of the updated policy, and may monitor the implementation of the updated policy based on the new real-time data.

In some implementations, the management system 110 may utilize Boolean logic triggers available in MDM/UEM systems to dynamically adapt to events. For example, when the user device 105 enters a geofence (e.g., stadium, a precinct, an emergency area, and/or the like), the management system 110 can activate a slice policy to prioritize mission-critical application traffic. This may ensure that first responders and other key personnel have optimized device performance tailored to their specific operational needs. In another example, if a machine learning model predicts severe weather, the management system 110 may dynamically create a geofence and may deploy policies that prepare first responder devices with priority slices and custom experiences required for emergency situations. Similarly, if network congestion is predicted, premium customers can receive prioritized network paths through policy updates driven dynamically by the machine learning model.

In some implementations, the management system 110 can handle multiple triggers simultaneously to optimize user device performance. For example, the management system 110 may monitor and react to changes in geolocation, battery levels, and user changes concurrently. This capability may ensure that the policy generation process is comprehensive and accounts for various factors that may impact the performance of the user device 105. By integrating multiple triggers, the management system 110 may enhance responsiveness and adaptability to dynamic circumstances, providing a robust and well-rounded approach to device management.

In this way, the management system 110 utilizes machine learning to create a policy for device management. For example, the management system 110 may improve dynamic and adaptive mobile user device management by using real-time data and machine learning, which may enable the management system 110 to respond effectively to a wide array of network conditions and events. The management system 110 facilitates optimal policy enforcement and swift adaptation to critical events, ensuring that user devices 105 operate within predefined security and operational parameters. By automating policy creation and adaptation, the management system 110 may reduce the workload on IT personnel and may minimize the potential for errors associated with manual policy management. The generated policies may include rules for managing various functionalities of the user devices 105. The management system 110 may monitor feedback from implementation of the policies, and may update machine learning models based on the feedback to create improved policies. Additionally, the management system 110 may utilize inputs from network administrators, such as natural language inputs, to further refine policy generation. Thus, the management system 110 may conserve computing resources, networking resources, and/or other resources that would have otherwise been consumed by failing to properly adapt to dynamic events or contextual changes occurring in a network, failing to generate policies that adapt to the dynamic events or contextual changes occurring in a network, generating erroneous policies in response to the dynamic events or contextual changes occurring in a network, handling poor mobile device experiences caused by the erroneous policies, and/or the like.

As indicated above, FIGS. 1A-1D are provided as an example. Other examples may differ from what is described with regard to FIGS. 1A-1D. The number and arrangement of devices shown in FIGS. 1A-1D are provided as an example. In practice, there may be additional devices, fewer devices, different devices, or differently arranged devices than those shown in FIGS. 1A-1D. Furthermore, two or more devices shown in FIGS. 1A-1D may be implemented within a single device, or a single device shown in FIGS. 1A-1D may be implemented as multiple, distributed devices. Additionally, or alternatively, a set of devices (e.g., one or more devices) shown in FIGS. 1A-1D may perform one or more functions described as being performed by another set of devices shown in FIGS. 1A-1D.

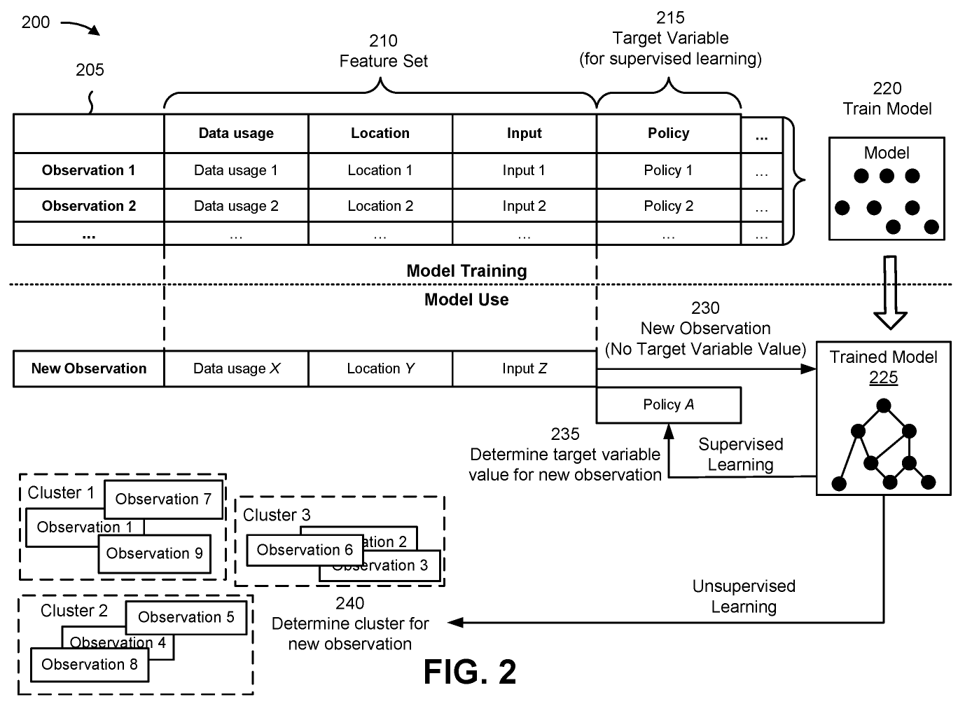

FIG. 2 is a diagram illustrating an example 200 of training and using a machine learning model. The machine learning model training and usage described herein may be performed using a machine learning system. The machine learning system may include or may be included in a computing device, a server, a cloud computing environment, and/or the like, such as the management system 110 described in more detail elsewhere herein.

As shown by reference number 205, a machine learning model may be trained using a set of observations. The set of observations may be obtained from historical data, such as data gathered during one or more processes described herein. In some implementations, the machine learning system may receive the set of observations (e.g., as input) from the management system 110, as described elsewhere herein.

As shown by reference number 210, the set of observations includes a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the management system 110. For example, the machine learning system may identify a feature set (e.g., one or more features and/or feature values) by extracting the feature set from structured data, by performing natural language processing to extract the feature set from unstructured data, by receiving input from an operator, and/or the like.

As an example, a feature set for a set of observations may include a first feature of data usage, a second feature of location, a third feature of input, and so on. As shown, for a first observation, the first feature may have a value of data usage 1, the second feature may have a value of location 1, the third feature may have a value of input 1, and so on. These features and feature values are provided as examples and may differ in other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiple classes, classifications, labels, and/or the like), may represent a variable having a Boolean value, and/or the like. A target variable may be associated with a target variable value, and a target variable value may be specific to an observation. In example 200, the target variable may be entitled “policy” and may include a value of policy 1 for the first observation.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, and/or the like. After training, the machine learning system may store the machine learning model as a trained machine learning model 225 to be used to analyze new observations.

As shown by reference number 230, the machine learning system may apply the trained machine learning model 225 to a new observation, such as by receiving a new observation and inputting the new observation to the trained machine learning model 225. As shown, the new observation may include a first feature of data usage X, a second feature of location Y, a third feature of input Z, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs, information that indicates a degree of similarity between the new observation and one or more other observations, and/or the like, such as when unsupervised learning is employed.

As an example, the trained machine learning model 225 may predict a value of policy A for the target variable of the policy for the new observation, as shown by reference number 235. Based on this prediction, the machine learning system may provide a first recommendation, may provide output for determination of a first recommendation, may perform a first automated action, may cause a first automated action to be performed (e.g., by instructing another device to perform the automated action), and/or the like.

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., a data usage cluster), then the machine learning system may provide a first recommendation. Additionally, or alternatively, the machine learning system may perform a first automated action and/or may cause a first automated action to be performed (e.g., by instructing another device to perform the automated action) based on classifying the new observation in the first cluster.

As another example, if the machine learning system were to classify the new observation in a second cluster (e.g., a location cluster), then the machine learning system may provide a second (e.g., different) recommendation and/or may perform or cause performance of a second (e.g., different) automated action.

In some implementations, the recommendation and/or the automated action associated with the new observation may be based on a target variable value having a particular label (e.g., classification, categorization, and/or the like), may be based on whether a target variable value satisfies one or more thresholds (e.g., whether the target variable value is greater than a threshold, is less than a threshold, is equal to a threshold, falls within a range of threshold values, and/or the like), may be based on a cluster in which the new observation is classified, and/or the like.

In this way, the machine learning system may apply a rigorous and automated process to generate a mobile device management policy. The machine learning system enables recognition and/or identification of tens, hundreds, thousands, or millions of features and/or feature values for tens, hundreds, thousands, or millions of observations, thereby increasing accuracy and consistency and reducing delay associated with generating a mobile device management policy relative to requiring computing resources to be allocated for tens, hundreds, or thousands of operators to manually generate a mobile device management policy.

As indicated above, FIG. 2 is provided as an example. Other examples may differ from what is described in connection with FIG. 2.

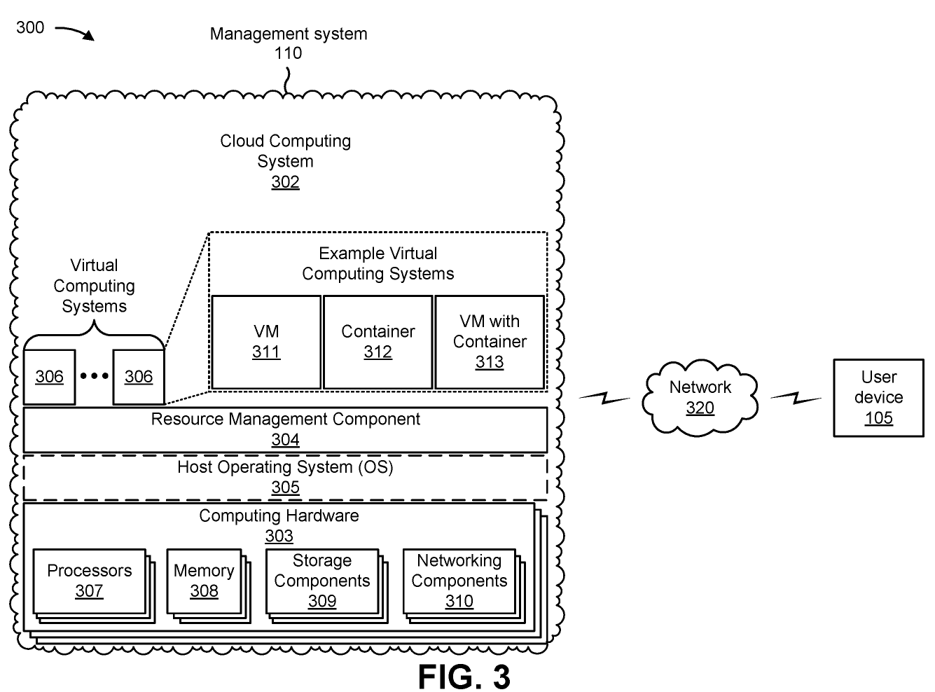

FIG. 3 is a diagram of an example environment 300 in which systems and/or methods described herein may be implemented. As shown in FIG. 3, the environment 300 may include the management system 110, which may include one or more elements of and/or may execute within a cloud computing system 302. The cloud computing system 302 may include one or more elements 303-313, as described in more detail below. As further shown in FIG. 3, the environment 300 may include the user device 105 and/or a network 320. Devices and/or elements of the environment 300 may interconnect via wired connections and/or wireless connections.

The user device 105 may include one or more devices capable of receiving, generating, storing, processing, and/or providing information, as described elsewhere herein. The user device 105 may include a communication device and/or a computing device. For example, the user device 105 may include a wireless communication device, a mobile phone, a smartphone, a noise meter, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The cloud computing system 302 includes computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of the computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from the computing hardware 303 of the single computing device. In this way, the computing hardware 303 can operate more efficiently, with lower power consumption, higher reliability, higher availability, higher utilization, greater flexibility, and lower cost than using separate computing devices.

The computing hardware 303 includes hardware and corresponding resources from one or more computing devices. For example, the computing hardware 303 may include hardware from a single computing device (e.g., a single server) or from multiple computing devices (e.g., multiple servers), such as multiple computing devices in one or more data centers. As shown, the computing hardware 303 may include one or more processors 307, one or more memories 308, one or more storage components 309, and/or one or more networking components 310. Examples of a processor, a memory, a storage component, and a networking component (e.g., a communication component) are described elsewhere herein.

The resource management component 304 includes a virtualization application (e.g., executing on hardware, such as the computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 311. Additionally, or alternatively, the resource management component 304 may include a container manager, such as when the virtual computing systems 306 are containers 312. In some implementations, the resource management component 304 executes within and/or in coordination with a host operating system 305.

A virtual computing system 306 includes a virtual environment that enables cloud-based execution of operations and/or processes described herein using the computing hardware 303. As shown, the virtual computing system 306 may include a virtual machine 311, a container 312, or a hybrid environment 313 that includes a virtual machine and a container, among other examples. The virtual computing system 306 may execute one or more applications using a file system that includes binary files, software libraries, and/or other resources required to execute applications on a guest operating system (e.g., within the virtual computing system 306) or the host operating system 305.

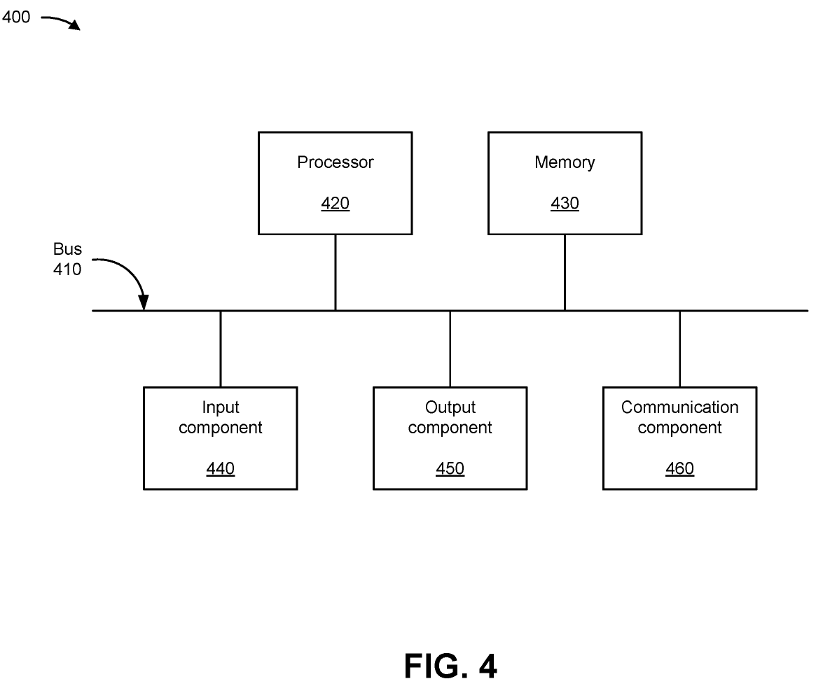

Although the management system 110 may include one or more elements 303-313 of the cloud computing system 302, may execute within the cloud computing system 302, and/or may be hosted within the cloud computing system 302, in some implementations, the management system 110 may not be cloud-based (e.g., may be implemented outside of a cloud computing system) or may be partially cloud-based. For example, the management system 110 may include one or more devices that are not part of the cloud computing system 302, such as a device 400 of FIG. 4, which may include a standalone server or another type of computing device. The management system 110 may perform one or more operations and/or processes described in more detail elsewhere herein.

The network 320 includes one or more wired and/or wireless networks. For example, the network 320 may include a cellular network, a public land mobile network (PLMN), a local area network (LAN), a wide area network (WAN), a private network, the Internet, and/or a combination of these or other types of networks. The network 320 enables communication among the devices of the environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400, which may correspond to the user device 105 and/or the management system 110. In some implementations, the user device 105 and/or the management system 110 may include one or more devices 400 and/or one or more components of the device 400. As shown in FIG. 4, the device 400 may include a bus 410, a processor 420, a memory 430, an input component 440, an output component 450, and a communication component 460.

The bus 410 includes one or more components that enable wired and/or wireless communication among the components of the device 400. The bus 410 may couple together two or more components of FIG. 4, such as via operative coupling, communicative coupling, electronic coupling, and/or electric coupling. The processor 420 includes a central processing unit, a graphics processing unit, a microprocessor, a controller, a microcontroller, a digital signal processor, a field-programmable gate array, an application-specific integrated circuit, and/or another type of processing component. The processor 420 is implemented in hardware, firmware, or a combination of hardware and software. In some implementations, the processor 420 includes one or more processors capable of being programmed to perform one or more operations or processes described elsewhere herein.

The memory 430 includes volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 stores information, instructions, and/or software (e.g., one or more software applications) related to the operation of the device 400. In some implementations, the memory 430 includes one or more memories that are coupled to one or more processors (e.g., the processor 420), such as via the bus 410.

The input component 440 enables the device 400 to receive input, such as user input and/or sensed input. For example, the input component 440 may include a touch screen, a keyboard, a keypad, a mouse, a button, a microphone, a switch, a sensor, a global positioning system sensor, an accelerometer, a gyroscope, and/or an actuator. The output component 450 enables the device 400 to provide output, such as via a display, a speaker, and/or a light-emitting diode. The communication component 460 enables the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., the memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

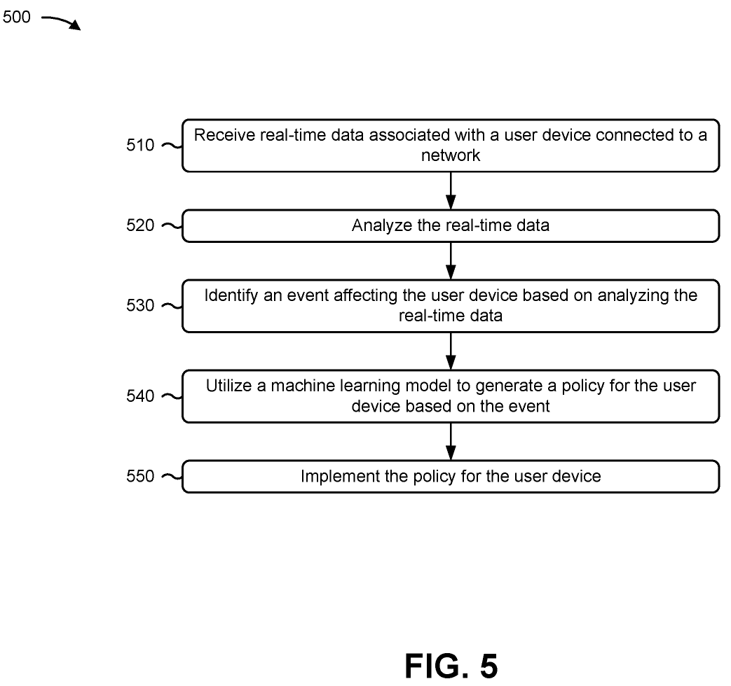

FIG. 5 depicts a flowchart of an example process 500 for utilizing machine learning to create a policy for device management. In some implementations, one or more process blocks of FIG. 5 may be performed by a device (e.g., the management system 110). In some implementations, one or more process blocks of FIG. 5 may be performed by another device or a group of devices separate from or including the device, such as a user device (e.g., the user device 105). Additionally, or alternatively, one or more process blocks of FIG. 5 may be performed by one or more components of the device 400, such as the processor 420, the memory 430, the input component 440, the output component 450, and/or the communication component 460.

As shown in FIG. 5, process 500 may include receiving real-time data associated with a user device connected to a network (block 510). For example, the device may receive real-time data associated with a user device connected to a network, as described above. In some implementations, the real-time data includes one or more of data usage data associated with the user device, location data associated with the user device, available memory data associated with the user device, environmental condition data associated with the user device, a roaming status of the user device, encrypting storage data associated with the user device, a battery level of the user device, an operating system version of the user device, or identification of a user of the user device.

As further shown in FIG. 5, process 500 may include analyzing the real-time data (block 520). For example, the device may analyze the real-time data, as described above.

As further shown in FIG. 5, process 500 may include identifying an event affecting the user device based on analyzing the real-time data (block 530). For example, the device may identify an event affecting the user device based on analyzing the real-time data, as described above.

As further shown in FIG. 5, process 500 may include utilizing a machine learning model to generate a policy for the user device based on the event (block 540). For example, the device may utilize a machine learning model to generate a policy for the user device based on the event, as described above. In some implementations, the policy includes one or more rules for managing one or more functionalities of the user device. In some implementations, the machine learning model is a neural network model.

As further shown in FIG. 5, process 500 may include implementing the policy for the user device (block 550). For example, the device may implement the policy for the user device, as described above. In some implementations, implementing the policy for the user device includes deploying the policy to adjust one or more functionalities of the user device in response one or more events occurring in the network. In some implementations, implementing the policy for the user device includes prioritizing one or more resources of the network for the user device based on the policy. In some implementations, implementing the policy for the user device includes updating software or one or more applications on the user device based on the policy. In some implementations, implementing the policy for the user device includes changing one or more security settings on the user device based on the policy.

In some implementations, process 500 includes monitoring implementation of the policy for the user device, receiving performance data based on monitoring the implementation of the policy for the user device, and updating the machine learning model based on the performance data to generate an updated machine learning model. In some implementations, process 500 includes providing the performance data for display to an administrator of the network. In some implementations, process 500 includes generating an updated policy for the user device based on the updated machine learning model, implementing the updated policy for the user device, and monitoring implementation of the updated policy for the user device.

In some implementations, process 500 includes receiving an input associated with the event from an administrator of the network, and utilizing the machine learning model to generate the policy for the user device includes utilizing the machine learning model to generate the policy for the user device based on the input and the event. In some implementations, the input is a natural language input generated by the administrator based on the event.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code - it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

As used herein, “selectively” performing an operation means to either perform the operation or refrain from performing the operation. For example, selectively performing an operation based on whether a condition is satisfied means that the operation is performed if the condition is satisfied and that the operation is not performed if the condition is not satisfied (or vice versa). Thus, selectively performing an operation may include determining whether to perform the operation and then either performing the operation or refraining from performing the operation based on that determination.

As used herein, “selectively” performing a first operation or a second operation means to perform either the first operation or the second operation. For example, selectively performing a first operation or a second operation based on whether a condition is satisfied means that the first operation is performed if the condition is satisfied and that the second operation is performed if the condition is not satisfied (or vice versa). Thus, selectively performing a first operation or a second operation may include determining whether to perform either the first operation or the second operation and then performing either the first operation or the second operation based on that determination.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, real-time data associated with a user device connected to a network;
analyzing, by the device, the real-time data;
identifying, by the device, an event affecting the user device based on analyzing the real-time data;
utilizing, by the device, a machine learning model to generate a policy for the user device based on the event; and
implementing, by the device, the policy for the user device.

2. The method of claim 1, wherein the policy includes one or more rules for managing one or more functionalities of the user device.

3. The method of claim 1, wherein implementing the policy for the user device comprises:
deploying the policy to adjust one or more functionalities of the user device in response to one or more events occurring in the network.

4. The method of claim 1, further comprising:
monitoring implementation of the policy for the user device;
receiving performance data based on monitoring the implementation of the policy for the user device; and
updating the machine learning model based on the performance data to generate an updated machine learning model.

5. The method of claim 4, further comprising:
providing the performance data for display to an administrator of the network.

6. The method of claim 4, further comprising:
generating an updated policy for the user device based on the updated machine learning model;
implementing the updated policy for the user device; and
monitoring implementation of the updated policy for the user device.

7. The method of claim 1, wherein the real-time data includes one or more of:
data usage data associated with the user device,
location data associated with the user device,
available memory data associated with the user device,
environmental condition data associated with the user device,
a roaming status of the user device,
encrypted storage data associated with the user device,
a battery level of the user device,
an operating system version of the user device, or
identification of a user of the user device.

8. A device, comprising:
one or more processors configured to:
receive real-time data associated with a user device connected to a network;
analyze the real-time data;
identify an event affecting the user device based on analyzing the real-time data;
utilize a machine learning model to generate a policy for the user device based on the event;
implement the policy for the user device;
monitor implementation of the policy for the user device;
receive performance data based on monitoring the implementation of the policy for the user device; and
update the machine learning model based on the performance data to generate an updated machine learning model.

9. The device of claim 8, wherein the machine learning model is a neural network model.

10. The device of claim 8, wherein the one or more processors are further configured to:
receive an input associated with the event from an administrator of the network,
wherein the one or more processors, to utilize the machine learning model to generate the policy for the user device, are configured to:
utilize the machine learning model to generate the policy for the user device based on the input and the event.

11. The device of claim 10, wherein the input is a natural language input generated by the administrator based on the event.

12. The device of claim 8, wherein the one or more processors, to implement the policy for the user device, are configured to:
prioritize one or more resources of the network for the user device based on the policy.

13. The device of claim 8, wherein the one or more processors, to implement the policy for the user device, are configured to:
update software or one or more applications on the user device based on the policy.

14. The device of claim 8, wherein the one or more processors, to implement the policy for the user device, are configured to:
change one or more security settings on the user device based on the policy.

15. A non-transitory computer-readable medium storing a set of instructions, the set of instructions comprising:
one or more instructions that, when executed by one or more processors of a device, cause the device to:
receive real-time data associated with a user device connected to a network;
analyze the real-time data;
identify an event affecting the user device based on analyzing the real-time data;
utilize a machine learning model to generate a policy for the user device based on the event,
wherein the policy includes one or more rules for managing one or more functionalities of the user device; and
implement the policy for the user device.

16. The non-transitory computer-readable medium of claim 15, wherein the one or more instructions, that cause the device to implement the policy for the user device, cause the device to:
deploy the policy to adjust one or more functionalities of the user device in response one or more events occurring in the network.

17. The non-transitory computer-readable medium of claim 15, wherein the one or more instructions further cause the device to:
monitor implementation of the policy for the user device;
receive performance data based on monitoring the implementation of the policy for the user device;
update the machine learning model based on the performance data to generate an updated machine learning model;
generate an updated policy for the user device based on the updated machine learning model; and
implement the updated policy for the user device.

18. The non-transitory computer-readable medium of claim 15, wherein the one or more instructions further cause the device to:
receive an input associated with the event from an administrator of the network,
wherein the input is a natural language input generated by the administrator based on the event,
wherein the one or more instructions, that cause the device to utilize the machine learning model to generate the policy for the user device, cause the device to:
utilize the machine learning model to generate the policy for the user device based on the input and the event.

19. The non-transitory computer-readable medium of claim 15, wherein the one or more instructions, that cause the device to implement the policy for the user device, cause the device to:
prioritize one or more resources of the network for the user device based on the policy.

20. The non-transitory computer-readable medium of claim 15, wherein the one or more instructions, that cause the device to implement the policy for the user device, cause the device to:
update software, one or more applications, or one or more security settings on the user device based on the policy.
